(19) United States
(12) Patent Application Publication
(10) Pub. No.: US 2009/0241743 A1
(43) Pub. Date: Oct. 1, 2009

(54) ELECTRONIC TORQUE SPANNER WITH EXPANSION MEMBER

(76) Inventor: CHIH-CHING HSIEH, Taichung City (TW)

Correspondence Address: Chien-Hui Su, P. O. Box 70-121 Taichung, Taichung City, 40899, TW

(21) Appl. No.: 12/057,363

(22) Filed: Mar. 27, 2008

(51) Int. Cl. B25B 23/144

(52) U.S. Cl. 81/467

(57) ABSTRACT

An electronic torque spanner includes a spanner body and an expansion member. The spanner body includes a driving head and a handle. A display and control unit and a receive port are install on the handle. The display and control unit connects with the receive port electrically. A sensor is installed within the driving head and connects with the display and control unit electrically to transmit the operation information to display and control unit. The expansion member corresponds with the receive port to launch the display and control unit. The expansion member and the display and control unit transmit data each other by the receive port. For difference purpose, the expansion member has the function of operation statistics, identification, anti-theft, or seeking.

### FIELD OF THE INVENTION

The present invention relates to an electronic torque spanner with an expansion member. In particularly, the expansion member has the function of operation statistics, identification, anti-theft, or seeking.

### BACKGROUND OF THE INVENTION

Spanners are frequently used in works. Generally, a spanner has a head for driving a screwing object. In some works, it is necessary to control the force applied to the screwing object so as to prevent the spanner or screwing object from damage or giving a proper engaging level to the screwing object so that it can be locked to an object properly. Thus electronic torque spanner is developed.

For example, U.S. Pat. No. 4,958,541 discloses the electronic torque wrench with tactile indication. The electronic torque wrench has a hollow handle portion in which are disposed a DC motor mechanically coupled to the handle portion with a mass eccentrically mounted on its shaft, a control circuit for the motor and a battery for powering the motor and the control circuit. A strain sensor on the wrench produces an output signal when the torque applied to a workpiece equals or exceeds a predetermined torque level for causing the control circuit to actuate the motor to vibrate the handle portion and provide a tactile indication to the user.

However, the prior art still has some defects. The usage of electronic torque spanner is not recorded. How long is the spanner being used? How many times is the spanner being operated? Who has the authorization of use? If the user put the spanner in the wrong place, how to seek it? Thus there is an eager demand for a novel design which can improve the defects in the prior art.

### SUMMARY OF THE INVENTION

Accordingly, the primary object of the present invention is to provide an electronic torque spanner with an expansion member, in that a multifunction electronic torque spanner is obtained.

To achieve the above objectives, the present invention provides an electronic torque spanner comprising a spanner body having a display and control unit and a receive port, the display and control unit connected with the receive port electrically; an expansion member corresponded with the receive port to launch the display and control unit; and wherein the expansion member and the display and control unit transmit data each other by the receive port.

The various objectives and advantages of the present invention will be more readily understood from the following detailed description when read in conjunction with the appended drawing.

### BRIEF DESCRIPTION OF THE DRAWINGS

FIG. 1 is a schematic perspective view about the first embodiment of the present invention.

FIG. 2 shows the operation about the first embodiment of the present invention.

FIG. 3 is a schematic perspective view about the second embodiment of the present invention.

FIG. 4 shows the operation of the buzzer about the second embodiment of the present invention.

FIG. 5 is a schematic perspective view about the third embodiment of the present invention.

### DETAILED DESCRIPTION OF THE INVENTION

In order that those skilled in the art can further understand the present invention, a description will be provided in details below. However, these descriptions and the appended drawings are only used for those skilled in the art to understand the objects, features, and characteristics of the present invention, but not to be used to confine the scope and spirit of the present invention defined in the appended claims.

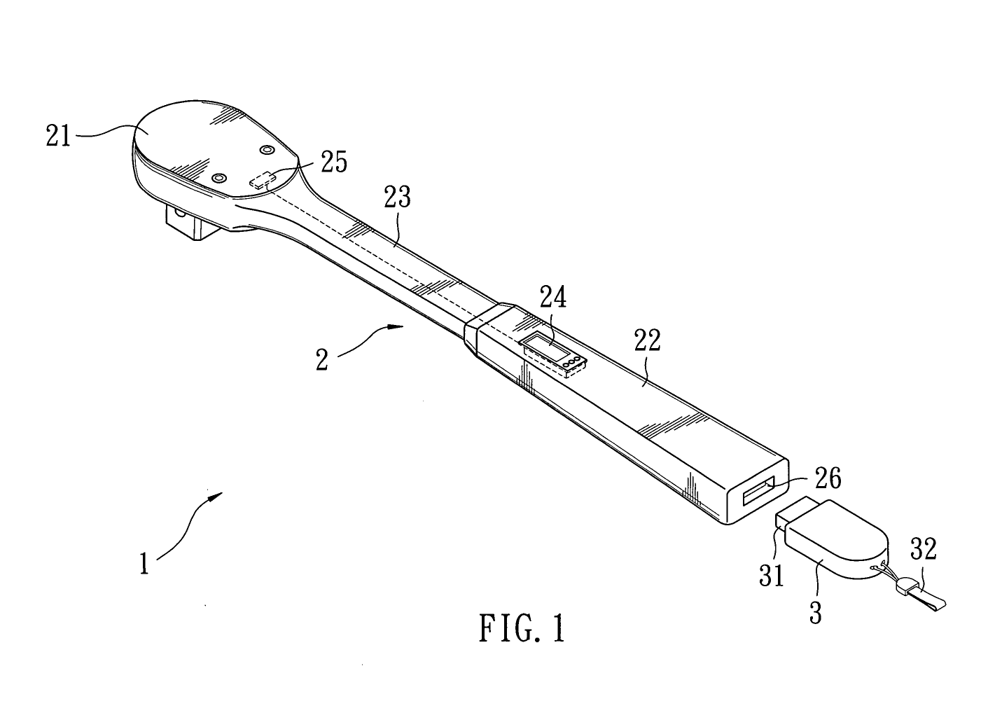

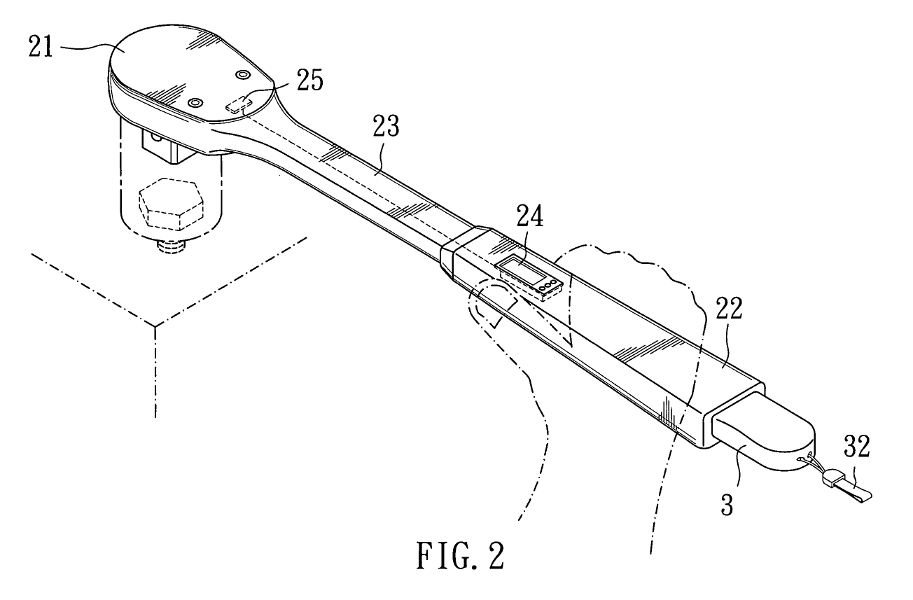

Referring FIG. 1 and FIG. 2, an electronic torque spanner 1 according to the present invention is illustrated. The electronic torque spanner 1 includes a spanner body 2 and an expansion member 3.

The spanner body 2 according to the present invention is illustrated with a socket spanner, but it can be various as desired. The spanner body 2 includes a driving head 21 and a handle 22. The driving head 21 and the handle 22 are connected by an extension rod 23. A sensor 25 is installed within the driving head 21 to sense the operation information. In this embodiment the sensor 25 is a strain gauge. A display and control unit 24 and a receive port 26 are installed on the handle 22. The sensor 25 and the receive port 26 respectively connect with the display and control unit 24 electrically. The display and control unit 24 is used for switching, numerical setting, data processing, and displaying. The receive port 26 may be various as USB port, RS-232 port, Bluetooth, or infrared port.

The expansion member 3 includes a plug 31 and a sling 32. The plug 31 is corresponding to the receive port 26. The sling 32 is used for carrying the expansion member 3 easily.

FIG. 2 shows the operation about the first embodiment of the present invention. When user plugs the expansion member 3 into the receive port 26, the display and control unit 24 will launch. When the driving head 21 is used to fasten or unfasten the screw, the strain value measured by the sensor 25 will be sent to the display and control unit 24. The display and control unit 24 will compute the torque value, operation time, and operation count and display that information. Those operation histories, user name, torque value, operation time, and operation count, will be sent by receive port 26 and be recorded in the expansion member 3. After user unplugs the expansion member 3, the display and control unit 24 will stop. The purpose of anti-theft is attained.

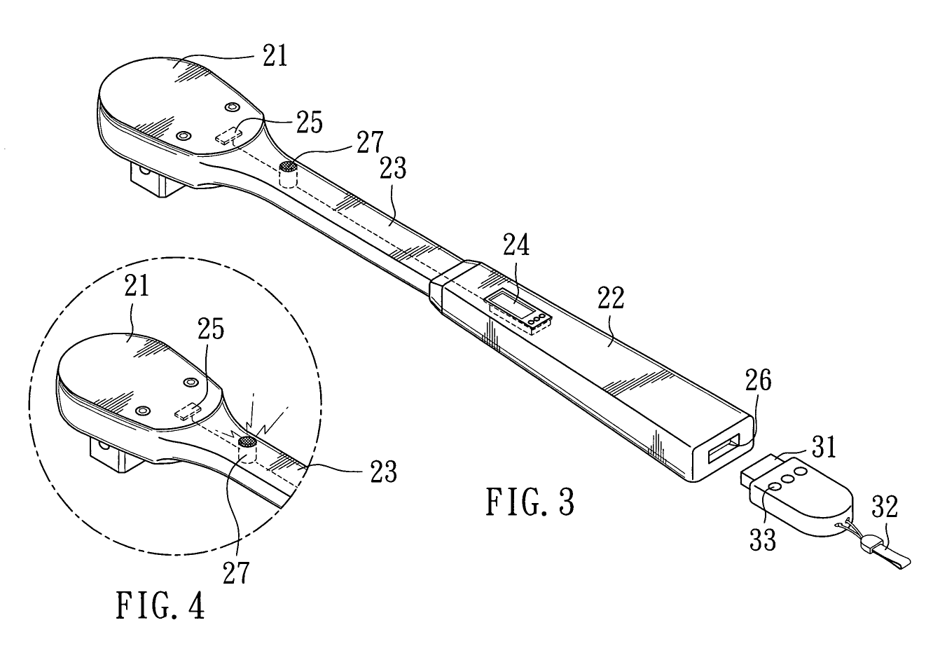

FIGS. 3 and 4 show the second embodiment according to the present invention. In this embodiment, those identical to the above embodiment will not be further described herein. Only those different from above embodiment are described. In this embodiment, a buzzer 27 which connects with the display and control unit 24 electrically is installed on the extension rod 23. And the expansion member 3 includes a remote control 33. By pressing the remote control 33, the buzzer 27 may sound or the display and control unit 24 may flash to seek the corresponding spanner body 2 quickly.

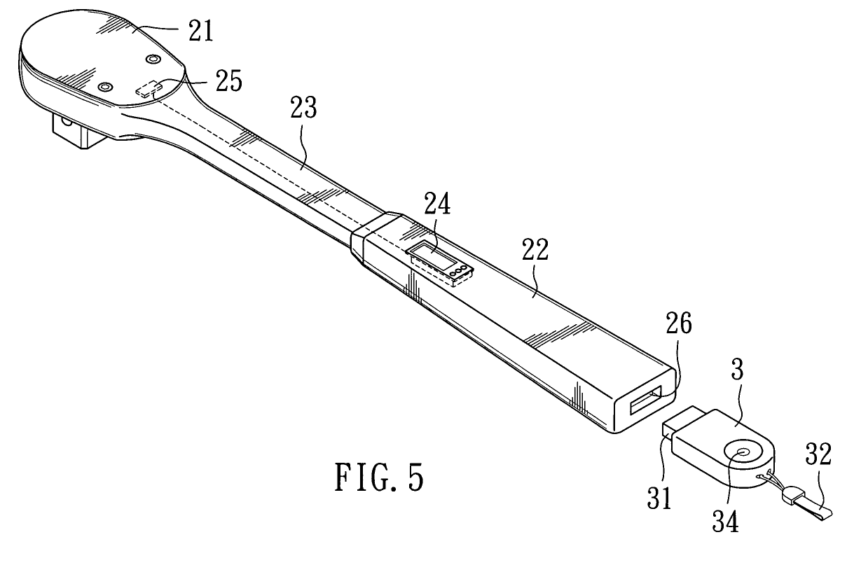

FIG. 5 shows the third embodiment according to the prevent invention. In this embodiment, the expansion member 3 includes a fingerprint recognition unit 34. By scanning the correct fingerprint, the display and control unit 24 will launch. The identification of user will be confirmed.

However, above mentioned embodiments are just examples of the present invention, they are not confined the scope of the present invention. The forms of the driving head and the receive port may be varied as desired.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electronic torque spanner comprising:
a spanner body having a display and control unit and a receive port, the display and control unit connected with the receive port electrically;
an expansion member corresponded with the receive port to launch the display and control unit; and
wherein the expansion member and the display and control unit transmit data each other by the receive port.

2. The electronic torque spanner as claimed in claim 1, wherein the spanner body includes a buzzer connected with the display and control unit electrically, the expansion member includes a remote control to make the buzzer sounded or make the display and control unit flashed.

3. The electronic torque spanner as claimed in claim 1, wherein the expansion member includes a fingerprint recognition unit.

4. The electronic torque spanner as claimed in claim 1, wherein the expansion member includes a plug to correspond with the receive port.

5. The electronic torque spanner as claimed in claim 1, wherein the spanner body includes a driving head, a sensor is installed within the driving head and connects with the display and control unit electrically.

6. The electronic torque spanner as claimed in claim 1, wherein the spanner body includes a handle, the display and control unit and the receive port are install on the handle.

7. The electronic torque spanner as claimed in claim 1, wherein the expansion member includes a sling for carrying.
